(19) United States
(12) Patent Application Publication
(10) Pub. No.: US 2004/0206310 A1
(43) Pub. Date: Oct. 21, 2004

(54) Voice receiver and annunciator for pets

(76) Inventor: Jeffrey A. Hutchins, Leeds, ME (US)

Correspondence Address: BOHAN, MATHERS & ASSOCIATES, LLC, PO BOX 17707, PORTLAND, ME, 04112-8707, US

(21) Appl. No.: 10/417,479

(22) Filed: Apr. 17, 2003

(51) Int. Cl. A01K 15/02; A01K 15/04

(52) U.S. Cl. 119/720

(57) ABSTRACT

A receiver/emitter unit that is attachable to a conventional animal collar or harness, and a transmitter unit used by an animal handler. The receiver/emitter unit renders the received signal audible through a loudspeaker, enabling voice commands to be transmitted from handler to animal over distances greater than speaking voice range, thereby enabling the handler to exercise voice control over the animal, without resorting to a shock device.

### BACKGROUND OF THE INVENTION

1. Field of the Invention

The invention relates to the field of animal control devices. More particularly it relates to self-contained units that are either temporarily or semi-permanently attached to an existing animal collar or harness to augment control of animal behavior via voice commands by the pet owner or handler.

2. Description of Prior Art

In the field of animal training and handling, animals are typically given voice commands issued by the handler. Inherent in this technique is the problem that such commands are only effective within a range defined by the distance across which the handler's voice is audible. Thus, if the animal moves outside of this range, the voice commands become inaudible and, consequently, ineffective. Furthermore, the tone and inflection of the command are often more important as control signals to the animal than mere audibility and, so, even if the animal remains within the audible range of the handler's voice, voice commands may still become ineffective because the customary tone and inflection may change dramatically when the handler has to project his voice beyond the normal range of his normal command voice.

These problems are particularly troublesome when dogs are trained to respond to voice commands, but, in executing their tasks, routinely travel beyond the range of the animal handler. For example, hunting dogs routinely travel beyond the audible range of the handler's “normal” command voice in their efforts to detect and retrieve game. Dogs used in law enforcement, in rescue operations or for living assistance for disabled persons are also often trained to respond to voice commands, yet may travel beyond the voice-audibility range of the handler. Also, in some situations, the distance between animal and animal handler may not be great, but ambient conditions are such that it is difficult for the handler to communicate with the animal. Dog sled mushers, for example, have many and varied voice commands for the lead dog and must shout to be heard by the lead dog over the noise of the other dogs.

In addition to voice commands, electronic means are often used to control animals, particularly dogs. Yarnall, Sr. et al. (U.S. Pat. No. 4,745,882) discloses an apparatus that includes a radio receiver/transmitter device attached to a dog collar. The purpose of this receiver/transmitter device is twofold. The first function is to detect the dog's proximity to a perimeter bounded by signal-broadcasting wire loops. If the dog comes within a specific distance to the perimeter, the device emits a corrective shock and/or warning tone. The second purpose of this receiver/transmitter device is to transmit an alarm signal to the dog's owner should the dog venture too close to, or beyond, the perimeter. The device permits the owner, upon receiving the alarm signal, to transmit voice commands to the dog by means of the receiver/transmitter unit attached to the dog's collar. The disadvantage of this apparatus is its incompatibility for use with a dog permitted to roam freely in the course of hunting, hiking, rescue operations, or while performing other functions. Rather, the receiver/transmitter device described by Yarnall, Sr., et al. is constructed to receive signals from an electronic confinement means and to enforce the confinement of an animal to a particular area by means of automatically transmitting an alarm tone and/or electric shock to the animal wearing the device.

Arthur et al. (U.S. Pat. No. 5,207,179) also discloses an apparatus that serves the purpose of confining an animal to a bounded area by means of a radio receiver attached to the animal's collar. When the animal approaches the perimeter of the confinement area, the collar emits a shock and/or audible corrective signal. The audible corrective signal can be in the form of voice commands from the owner. These voice commands, however, are not issued by the animal owner in real-time and in response to various situations, but rather, are pre-recorded commands stored within the apparatus, to be broadcast only when the animal transgresses the boundary.

Many pet owners are appalled at the thought of having their pet animals receive an electric shock, and for this reason, such electronic control means as disclosed by Yarnall, Sr. et al. and Arthur et al. are either totally unacceptable, or are used only on a short-term basis while the animal is concurrently being trained to respond to sound and sight commands.

Tobias (U.S. Pat. No. 4,967,696) discloses an apparatus that transmits voice commands from a handler to a receiver contained within the collar of an animal. Tobias discloses an apparatus comprising a receiver/emitter, power supply, and antenna array, all of which are integrally embedded within the animal collar. While this apparatus does have the advantage of permitting the handler to issue voice commands to an animal that is beyond the audible range of his or her voice, the construction of the receiving/emitting apparatus limits the versatility of the apparatus. In certain situations, one animal in need of rest may be replaced with another fresh one during a hunting or dog sled expedition. The entire Tobias apparatus including collar must be removed from the one animal and attached to the other animal. This works as long as the collar is approximately the same size for both animals. If not, additional apparatus on collars of various sizes has to be stocked.

In addition, the Tobias apparatus includes a length of coaxial cable embedded within the collar to provide a connection between the receiver unit and the antenna assembly. The cable has the disadvantages of decreasing the flexibility of the collar and providing a source of malfunction of the apparatus, as the cable can break due to repeated flexing of the collar. Such a break would likely not be detected by the handler until he or she attempted to issue a command to the animal intended to be controlled. The cable also adds weight to the collar, which may make it uncomfortable for the animal to wear, or restrict its use to animals of a certain minimum size and/or weight.

Animal handlers also often train animals to respond to hand signals. This technique, too, has the inherent drawback that the animal handler loses control of the animal when the animal is beyond the visibility range of the handler or the handler is blocked from view, perhaps by trees, underbrush, fences, etc. Many handlers use whistles to overcome visibility obstacles, but the use of whistles means that the animal must be trained to respond to them. Whistles are loud and are often not suitable for use in suburban or urban, or in other areas in which sharp noise is to be avoided.

One further disadvantage of the prior art devices is that they are all integrated into a collar. One can imagine an animal being trained in a new living or working situation and wearing a first collar with identification tags, a second collar with an electric shock device, and a third collar with a radio transmitter/receiver. The increase in the number of collars may cause discomfort for the animal and will certainly add extra weight.

What is needed, therefore, is apparatus for transmitting contemporaneously issued voice commands from an animal handler to an animal over distances greater than the audible range of the handler's command voice and/or when the animal is not within sight of the animal handler. What is further needed is such apparatus that is easily portable, small and lightweight, resistant to the elements, and durable for use in a variety of animal-related activities. What is still further needed is such apparatus that is easily attachable to and removable from a collar or harness and can be used to augment other animal training and control devices. Finally, what is needed is such apparatus that is economical to manufacture.

### SUMMARY OF THE INVENTION

It is therefore an object of the present invention to provide an apparatus for receiving and emitting voice commands from an animal handler over distances greater than the audible range of the handler's command voice and/or when the animal is not within sight of the animal handler. It is a further object to provide such apparatus that is of sufficiently lightweight construction that it can be employed with a wide variety of large and small animals, and durable enough in construction that it may be used for a wide variety of animal-related activities, and is small and easily portable. It is a still further object to provide an apparatus that is easily attachable to and removable from an animal collar or harness and can be used to augment other training and control devices. Finally, it is an object to provide an apparatus that is economical to manufacture.

The objects of the present invention have been achieved by providing apparatus for transmitting voice commands from an animal handler to an animal that is beyond the audible range of the handler's command voice, and that is readily attachable to and removable from an animal collar. The apparatus according to the invention comprises a lightweight, compact, modular receiver/emitter unit that attaches to an animal collar or harness and a lightweight, radio transmitter unit that is used by the animal handler. The receiver/emitter unit is housed in a durable, water-resistant casing that is attached with fasteners to the collar or harness of the animal. Any type of fastening means that is suitable for the purpose of attaching the receiver/emitter unit to the collar or harness may be used as a fastener for the apparatus according to the invention. Such fastening means may include, but are not limited to, adhesive and/or fabric hook and loop fasteners, threaded fasteners, clamps or clips, loops, snaps. etc. Alternatively, the receiver/emitter unit may be secured within a pouch or pocket that is easily and quickly attachable to the animal collar or harness with suitable fasteners.

The transmitter unit can be a hand-held unit or include means for quickly and easily attaching to and detaching from the handler's person. Such means may include, but are not limited to, hook-and-loop fasteners, clips, suspension cords to suspend the unit from the handler's neck, etc. In a further embodiment, a headset that includes a voice-activated microphone assembly may be plugged into the unit to allow hands-free use of the transmitter unit.

The apparatus according to the invention is used to control a pet, without the use of the commonly used shock devices. Indeed, it is a known fact that many pet owners are reluctant to use a shock collar on a pet. This fact leaves the pet owners without a means of controlling a pet that is beyond the normal range of voice commands. The apparatus according to the invention provides a means of controlling such a pet by voice commands only.

### BRIEF DESCRIPTION OF THE DRAWINGS

FIG. 1 illustrates the apparatus according to the invention in use.

FIG. 2A is a perspective front view of the Preferred Embodiment of the receiver/emitter unit according to the invention.

FIG. 2B is a perspective rear view of the Preferred Embodiment of the receiver/emitter unit according to the invention

FIG. 3 is a perspective view of the Preferred Embodiment of the transmitter unit according to the invention.

FIG. 4 shows the receiver/emitter unit of FIGS. 1A and 1B attached to a conventional animal collar.

FIG. 5 shows an alternative embodiment of the receiver/emitter unit according to the invention, in a water-tight pouch that is attachable to a collar or harness.

### DETAILED DESCRIPTION OF THE PREFERRED EMBODIMENT OF THE INVENTION

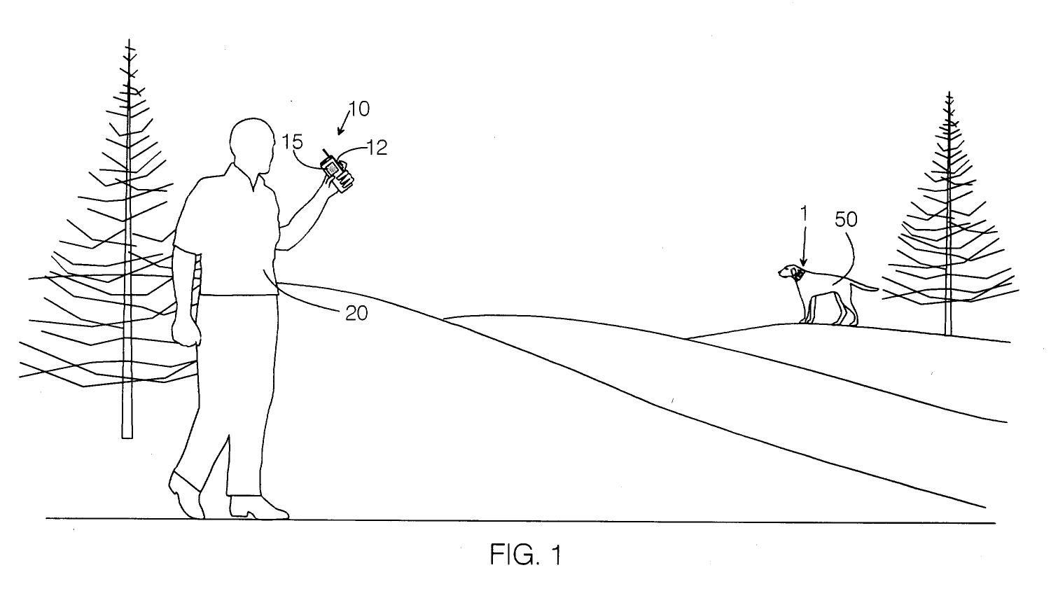

FIG. 1. shows the apparatus according to the invention. An animal handler 20 is holding a transmitter unit 10. Off in the distance is a dog 50 with a receiver/emitter unit 1 attached to its collar 8. The animal handler 20 gives voice commands to the dog 50 by speaking into the transmitter unit 10, using the accustomed tone and inflection in his voice. The dog 50, well beyond the audibility distance of the animal handler's voice, hears the voice commands through the receiver/emitter unit 1 that is attached to the collar 8. Ideally, the dog is trained to respond to specific voice commands and will react accordingly when it hears the voice command.

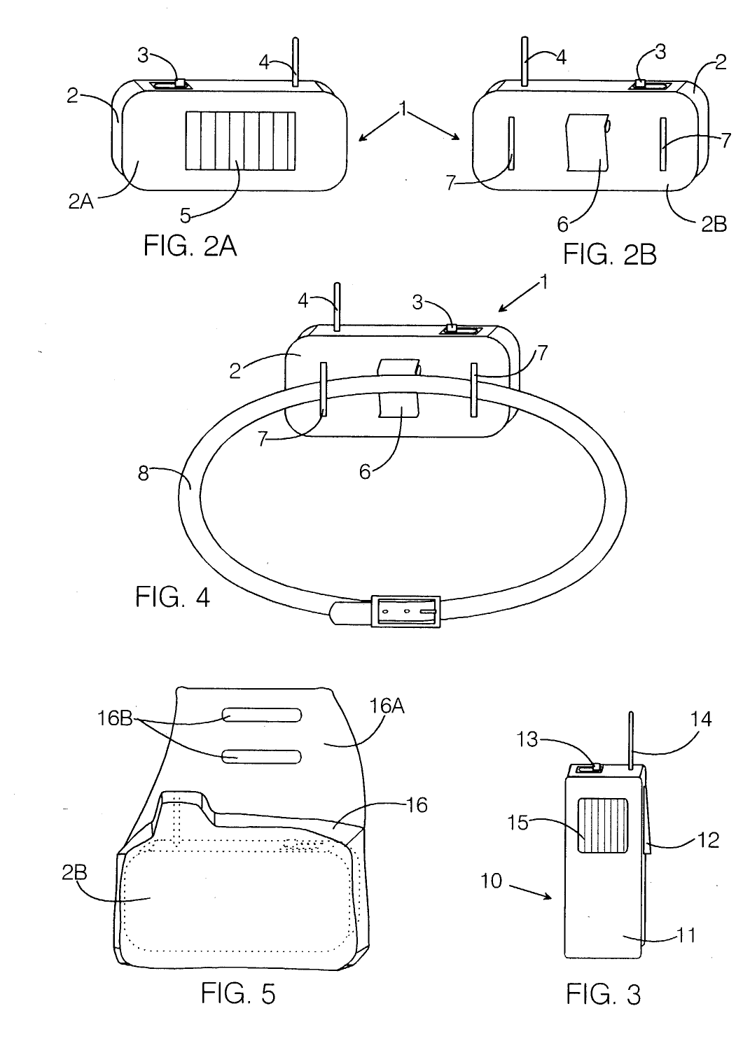

FIGS. 2A and 2B show the Preferred Embodiment of the receiver/emitter unit 1, comprising a durable, water-resistant housing 2 having a front face 2A and a rear face 2B, a power switch 3, an antenna assembly 4, and a loudspeaker 5. In the embodiment shown in FIGS. 2A and 2B, the antenna assembly 4 projects out of the housing 2. A dc power source is incorporated into the housing 2. The power is provided by one or more batteries. In the Preferred Embodiment, 6 Volts are used, although the amount of voltage and the number and size of the batteries is a function of the size and strength of the receiver/emitter unit 1. The rear face 2B of the receiver/emitter unit 1 housing bears a spring-clip assembly 6, as well as openings 7, for attaching the unit 1 to the collar 8.

FIG. 3 shows the Preferred Embodiment of the transmitter unit 10, comprising a durable, water-resistant housing 11, a transmit switch-button 12, a power switch 13, an antenna assembly 14, and an integral microphone assembly 15. As with the receiver/emitter unit 1 described above, batteries provide the energy to operate the transmitter unit 10.

FIG. 4 depicts the receiver/emitter unit 1 in its preferred embodiment, showing the rear side 2B attached to a conventional animal collar 8. The collar 8 passes through both openings 7, which, in the Preferred Embodiment, are loop-holes and integral to the housing 2 of the receiver/emitter unit 1. In the depicted configuration, the receiver/emitter unit 1 is semi-permanently affixed to the collar 8. Alternatively, the receiver/emitter unit 1 may be affixed to the collar 8 in a more temporary manner by attaching the device to the collar 8 by means of the spring-clip assembly 6.

For purposes of illustration, the antenna assemblies 4 and 14 are both shown as extending from the respective housings. Depending on the terrain and on the particular type of receiver/emitter or transmitter unit used, the antenna may be substantially contained within the housing.

FIG. 5 shows an alternative embodiment of the receiver/emitter unit 1 according to the invention, sealed in a water-resistant pouch 16. The pouch 16 has a tab 16A that is secured to the collar or harness 8. In the embodiment shown, strips of mating hook-and-loop fasteners 16B are used to secure the pouch 16 to the collar 8, although it should be understood that snaps or other suitable fastening means may be used and are included within the scope of the invention. The pouch may be a resealable pouch, to allow the unit 1 to be removed for battery replacement and other maintenance, or may be a disposable water-tight pouch that is replaced once it has been opened to remove the unit 1 for maintenance.

In a further embodiment of the apparatus, two-way radio units may be used for the receiver/emitter unit 1 and the transmitter unit 10. Such devices are commercially available in a variety of sizes and price ranges.

As can be seen in FIG. 1, the animal handler 20 holds the transmitter unit 10, depresses the transmit switch-button 12 and speaks into the microphone assembly 15. The handler's 20 voice commands are transmitted via radio waves to the receiver/emitter unit 1, which is affixed to the collar 8 of the animal 50 intended to be controlled. The radio signal is converted to an audio signal and projected through the loudspeaker 5, so that it is audible to the animal 50.

Although the Preferred Embodiment of the apparatus according to the invention is disclosed herein, this is not intended to be limiting. Rather, the general principles set forth herein are considered to be merely illustrative of the scope of the present invention and it is to be further understood that numerous changes may be made without straying from the scope of the present invention.

1. An apparatus for transmitting voice commands from an animal handler to an animal wearing a collar means, wherein said collar means includes any collar, harness, or a halter, said apparatus comprising:
a transmitter unit; and
a receiver/emitter unit housed in a receiver housing that includes an antenna that is integrated into said receiver housing;
wherein said receiver/emitter unit receives voice commands transmitted from said animal handier by said transmitter and emits an acoustic signal that is audible to said animal;
wherein said receiver/emitter unit, including said antenna, is attachable to and detachable from said collar means by fastening means, without any adaptation of said collar means.

2 (canceled)

3. The apparatus according to claim 1, wherein said fastening means includes means from the group consisting of fabric hook-and-loop fasteners, threaded fasteners, snap fasteners, ties, clamps, and clips.

4. The apparatus according to claim 1, wherein said housing includes said fastening means.

5. The apparatus according to claim 1, further comprising a water-tight pouch;
wherein said receiver/emitter unit; including said antenna, Is encased in said water-tight pouch and said fastening means is provided on said water-tight pouch.
